(19) United States
(12) Patent Application Publication
(10) Pub. No.: US 2012/0188473 A1
(43) Pub. Date: Jul. 26, 2012

(54) STEREO DISPLAY DEVICE, BACKLIGHT MODULE AND LIGHT SOURCE DRIVING METHOD THEREOF

(75) Inventors: Che-Wei Chang, Taoyuan County (TW); Hsiu-Hung Lin, Taipei County (TW)

(73) Assignee: Chunghwa Picture Tubes, LTD., Taoyuan (TW)

(21) Appl. No.: 13/174,792

(22) Filed: Jul. 1, 2011

(30) Foreign Application Priority Data
Jan. 25, 2011 (TW) 100102728

(51) Int. Cl. G02F 1/13357; H05B 37/02; G02B 27/22; F21V 7/22

(52) U.S. Cl. 349/15; 362/613; 315/312; 359/464

(57) ABSTRACT

A stereo display device, a backlight module and a light source driving method thereof are provided. The backlight module includes a light guide plate, a first light source, and a second light source. The first light source is providing a first spectrum light set to the light guide plate in a first display period of a first frame period. The second light source is providing a second spectrum light set to the light guide plate in a second display period of a second frame period. Effective spectrums of a second red spectrum light, a second green spectrum light, and a second blue spectrum light of the second spectrum light set are different from effective spectrums of a first red spectrum light, a first green spectrum light, a first blue spectrum light of the first spectrum light set.

### CROSS-REFERENCE TO RELATED APPLICATION

This application claims the priority benefit of Taiwan application serial No. 100102728, filed on Jan. 25, 2011. The entirety of the above-mentioned patent application is hereby incorporated by reference herein and made a part of this specification.

### BACKGROUND OF THE INVENTION

1. Technical Field

The invention relates to a display device, backlight module and light source driving method thereof, and particularly, relates to a stereo display device, backlight module and light source driving method thereof.

2. Description of Related Art

In recently years, with the continuous advancement of the display technology, viewers have more and more requirement on display quality (such as frame resolution or color saturation) of the display. However, besides the high frame resolution and high color saturation, for the viewers, whether the display can display the stereo frame is a purchase factor.

For the using appearance, the stereo display technology can be broadly divided into stereoscopic that the views need to wear special designed glasses and auto-stereoscopic that can be naked-eye viewing directly. Stereoscopic stereo display can be divided into color filter glasses, polarizing glasses and shutter glasses mode etc. The working principles of the stereoscopic stereo display mainly uses the display to send a left and right eye frame with special message, and makes left and right eye to see the left and right eye frame respectively through the choices of the handset glasses to form the stereo vision.

For the shutter glasses mode, since the display panel of the shutter glasses mode displays left and right eye frame alternatively, the shutter glasses controls left and right eye seen frames by controlling the transmittance of liquid crystal . However, the manners of controlling liquid crystal is more complex, so the cost the shutter glasses mode is higher. For the polarizing glasses mode, since polarizing panel uses odd pixel rows and even pixel rows to display left and right eye frames respectively, the resolution of the polarizing glasses is lower.

### SUMMARY OF THE INVENTION

Accordingly, the invention proposes a stereo display device, backlight module, and light source driving method thereof, the spectrums of the red light, green light, and blue light provided of two light sources are different respectively, and the two light sources respectively turned on at different display periods of different frame period. In addition, the two lens of the color filter glasses are designed to mask the color light provided by the two light source respectively, so that left and right eye can access the corresponding frame at different frame periods respectively.

An aspect of the invention provides a backlight module which includes a light guide plate, a first light source, and a second light source. The first light source disposed on a first side of the light guide plate, configured for providing a first spectrum light set in a first display period of a first frame period, and the first spectrum light set comprises a first red spectrum light, a first green spectrum light and a first blue spectrum light. The second light source disposed on a second side opposite to the first side of the light guide plate, configured for providing a second spectrum light set in a second display period of a second frame period, and the second spectrum light set comprises a second red spectrum light, a second green spectrum light and a second blue spectrum light, and the second frame period is different from the first frame period. Effective spectrums of the first red spectrum light and effective spectrums of the second red spectrum light are located on effective spectrums of a red light, and effective spectrums of the first red spectrum light and effective spectrums of the second red spectrum light are not overlapped. Effective spectrums of the first green spectrum light and effective spectrums of the second green spectrum light are located on effective spectrums of a green light, and effective spectrums of the first green spectrum light and effective spectrums of the second green spectrum light are not overlapped. Effective spectrums of the first blue spectrum light and effective spectrums of the second blue spectrum light are located on effective spectrums of a blue light, and effective spectrums of the first blue spectrum light and effective spectrums of the second blue spectrum light are not overlapped.

An aspect of the invention provides a stereo display device which includes a light guide plate, a display panel, a first light source, a second light source, and a color filter glasses. The display panel is disposed on the light guide plate. The first light source is disposed on a first side of the light guide plate, configured for providing a first spectrum light set in a first display period of a first frame period, and the first spectrum light set comprises a first red spectrum light, a first green spectrum light and a first blue spectrum light. The second light source is disposed on a second side opposite to the first side of the light guide plate, configured for providing a second spectrum light set in a second display period of a second frame period, and the second spectrum light set comprises a second red spectrum light, a second green spectrum light and a second blue spectrum light, and the second frame period is different from the first frame period. The color filter glasses has a first lens and a second lens, the first lens configured for masking the second spectrum light set, the second lens configured for masking the first spectrum light set. Effective spectrums of the first red spectrum light and effective spectrums of the second red spectrum light are located on effective spectrums of a red light, and effective spectrums of the first red spectrum light and effective spectrums of the second red spectrum light are not overlapped. Effective spectrums of the first green spectrum light and effective spectrums of the second green spectrum light are located on effective spectrums of a green light, and effective spectrums of the first green spectrum light and effective spectrums of the second green spectrum light are not overlapped. Effective spectrums of the first blue spectrum light and effective spectrums of the second blue spectrum light are located on effective spectrums of a blue light, and effective spectrums of the first blue spectrum light and effective spectrums of the second blue spectrum light are not overlapped.

According to an embodiment of the invention, the first light source comprises a first light emitting element and a first color filter. The first light emitting element is configured for providing a light in the first display period. The first color filter is configured for transferring the light to the first spectrum light set.

According to an embodiment of the invention, the second light source comprises a second light emitting element and a second color filter. The second light emitting element is configured for providing a light in the second display period. The second color filter is configured for transferring the light to the second spectrum light set.

According to an embodiment of the invention, the display panel is a LCD display panel.

According to an embodiment of the invention, sum of effective spectrums of the first red spectrum light and effective spectrums of the second red spectrum light equals effective spectrums of the red light. Sum of effective spectrums of the first green spectrum light and effective spectrums of the second green spectrum light equals effective spectrums of the green light. Sum of effective spectrums of the first blue spectrum light and effective spectrums of the second blue spectrum light equals effective spectrums of the blue light.

According to an embodiment of the invention, the first display period and the second display period are configured for displaying a left eye frame and a right eye frame respectively.

An aspect of the invention provides a light source driving method which is adapted for a backlight module having a first light source and a second light source. The first light source is configured for providing a first spectrum light set comprising a first red spectrum light, a first green spectrum light and a first blue spectrum light, and the second light source is configured for providing a second spectrum light set comprising a second red spectrum light, a second green spectrum light and a second blue spectrum light. Effective spectrums of the first red spectrum light and effective spectrums of the second red spectrum light are located on effective spectrums of a red light and not overlapped, effective spectrums of the first green spectrum light and effective spectrums of the second green spectrum light are located on effective spectrums of a green light and not overlapped, and effective spectrums of the first blue spectrum light and effective spectrums of the second blue spectrum light are located on effective spectrums of a blue light and not overlapped. The light source driving method comprises: the first light source and the second light source not providing the first spectrum light set and the second spectrum light set in a first writing period of a first frame period; the first light source providing the first spectrum light set, the second light source not providing the second spectrum light set in a first display period of the first frame period; the first light source and the second light source not providing the first spectrum light set and the second spectrum light set in a second writing period of a second frame period; the first light source not providing the first spectrum light set, the second light source providing the second spectrum light set in a second display period of the second frame period.

According to an embodiment of the invention, the first display period and the second display period are a vertical blanking period respectively.

According to an embodiment of the invention, the first frame period is neighbored to the second frame period.

In summary, the stereo display device, the backlight module and the light source driving method thereof according to the embodiments of the invention, the color filter glasses masks the second spectrum light set and the first spectrum light set respectively. The left eye frame is transmitted through the first spectrum light set so that received by the left eye, and the right eye frame is transmitted through the second spectrum light set so that received by the right eye. The cost of the color filter glasses is lower than shutter glasses so that it can reduce the costs, and the display mode of left eye frame and right eye frame are like shutter glasses mode, so the frame resolution of the color filter glasses is higher than the frame resolution of the polarizing glasses.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structure schematic diagram of a stereo display device in accordance with an embodiment of the invention.

FIG. 2 is a transmittance schematic diagram of transmittance of a color filter, a first color filter FL1, and a second color filter FL2 of the display panel 120 in accordance with an embodiment of the invention.

FIG. 3 is a driving schematic diagram of a first light source 133 and a second light source 135 in accordance with an embodiment of the invention.

FIG. 4 is a flowchart of the light source driving method in accordance with an embodiment of the invention.

### DESCRIPTION OF THE EXEMPLARY EMBODIMENTS

Reference will now be made in detail to the present embodiments of the invention, examples of which are illustrated in the accompanying drawings. Wherever possible, the same reference numbers are used in the drawings and the description to refer to the same or like parts.

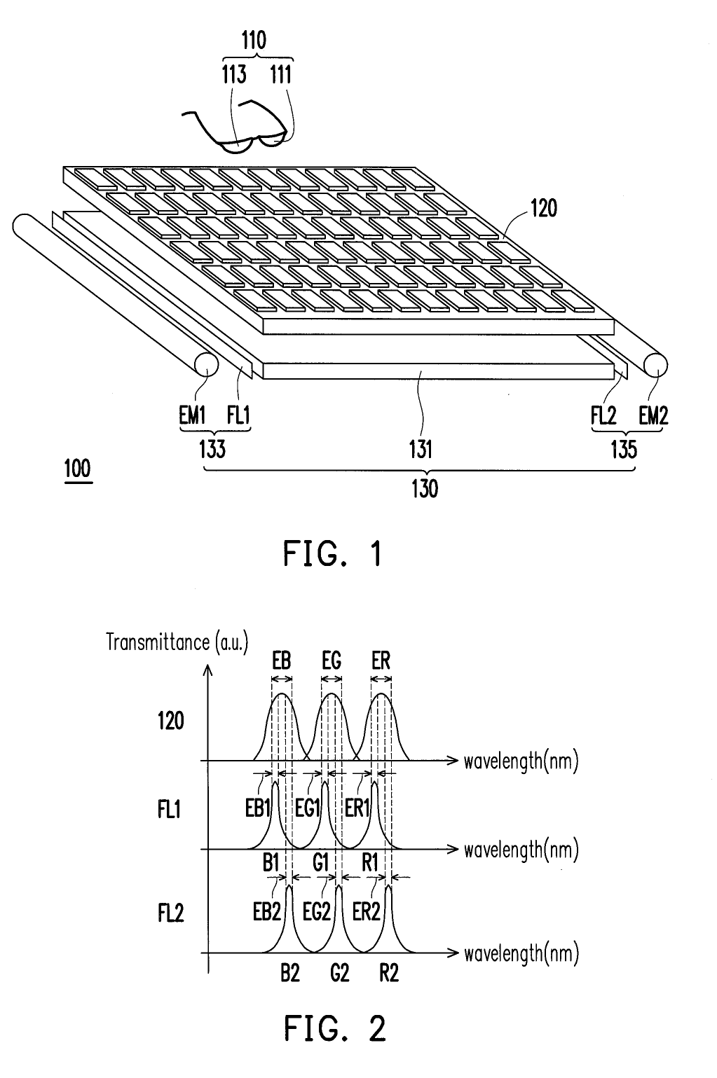

FIG. 1 is a structure schematic diagram of a stereo display device in accordance with an embodiment of the invention. Referring to FIG. 1, in the embodiment of the invention, a stereo display device 100 comprises color filter glasses 110, a display panel 120 and a backlight module 130. Display panel 120 is a LCD display panel in the embodiment, and multiple red color filters, green color filters and blue color filters are disposed on the display panel 120. The backlight module 130 comprises light guide plate 131, a first light source 133 and a second light source 135, and the first light source 133 and the second light source 135 provide a first spectrum light set and a second spectrum light set at different display periods of different frame periods.

The color filter glasses 110 comprise left lens 111 (as the first lens) and right lens 113 (as the second lens). Suppose the left lens 111 is configured to mask the second spectrum light set that means the first spectrum light set can penetrate the left eye lens 111, and the right lens 113 is configured to mask the first spectrum light, set that means the second spectrum light set can penetrate the right eye lens 113. Therefore, when the left eye frame is displayed, starts the first source light 133 after the left eye frame is wrote in the display panel 120 so as to transmit the left eye frame to the left eye through the first spectrum light set; otherwise, when the right eye frame is displayed, starts the second source light 135 after the right eye frame is wrote in display panel 120 so as to transmit the right eye frame to the right eye through the second spectrum light set.

In this embodiment, for example, the first light source 133 includes first light emitting element EM1 and first color filter FL1, the second light source 135 includes second light emitting element EM2 and second color filter FL2. For example, the first light emitting element EM1 and the second light emitting element EM2 can be cold cathode fluorescent lamps or light emitting diode series. The first light emitting light EM1 and the second light emitting source EM2 offer light in the different display periods of different frame periods respectively, and first color filter FL1 and second color filter FL2 transfer the light to the first spectrum light set and the second spectrum light set respectively. Moreover, first color filter FL1 and left eye lens 111 can use the same color filters, and second color filter FL2 and right eye lens 113 can use the same color filters.

FIG. 2 is a transmittance schematic diagram of transmittance of a color filter, a first color filter FL1, and a second color filter FL2 of the display panel 120 in accordance with an embodiment of the invention. Referring to FIG. 1 and FIG. 2, in this embodiment, effective spectrums of the red light that penetrated the display panel 120 are spectrums ER that means the light located on the spectrums ER can penetrate the red color filter of the display panel 120. Effective spectrums of the green light that penetrated the display panel 120 are spectrums EG that means the light located on the spectrums EG can penetrate the green color filter of the display panel 120. Effective spectrums of the blue light that penetrated the display panel 120 are spectrums EB that means the light located on the spectrums EB can penetrate the blue color filter of the display panel 120.

The first color filter FL1 is designed to three effective spectrums as ER1, EG1, and EB1 that can be penetrated by light, and FL2 is designed to three effective spectrums as ER2, EG2, and EB2 that can be penetrated by light. Effective spectrums ER1, EG1, EB1, ER2, EG2, and EB2 are not overlapped. Moreover, the effective spectrums ER1 and ER2 are located on the effective spectrums ER, the effective spectrums EG1 and EG2 are located on the effective spectrums EG, and the effective spectrums EB1 and EB2 are located on the effective spectrums EB.

Since the light located on the effective spectrums ER1 is in the range of the red light, the first color filter FL1 transfers the light to the first red spectrum light R1 by masking. Since the light located on the effective spectrums EG1 is in the range of the green light, the first color filter FL1 transfers the light to the first green spectrum light G1 by masking. Since the light located on the effective spectrums EB1 is in the range of the blue light, the first color filter FL1 transfers the light to the first blue spectrum light B1 by masking. The first red spectrum light R1, the first green spectrum light G1, and the first blue spectrum light B1 are the first spectrum light set in this embodiment.

On the other hand, Since the light located on the effective spectrums ER2 is in the range of the red light, the second color filter FL2 transfers the light to the second red spectrum light R2 by masking. Since the light located on the effective spectrums EG2 is in the range of the green light, the second color filter FL2 transfers the light to the second green spectrum light G2 by masking. Since the light located on the effective spectrums EB2 is in the range of the blue light, the second color filter FL2 transfers the light to the second blue spectrum light B2 by masking. The second red spectrum light R2, the second green spectrum light G2, and the second blue spectrum light B2 are the second spectrum light set in this embodiment.

In addition, in this embodiment, sum of the effective spectrums ER1 and the effective spectrums ER2 doesn't equal the effective spectrum ER, sum of the effective spectrums EG1 and the effective spectrums EG2 doesn't equal the effective spectrum EG, and sum of the effective spectrums EB1 and the effective spectrums EB2 doesn't equal the effective spectrum EB. But in other embodiments, sum of the effective spectrums ER1 and the effective spectrums ER2 equal the effective spectrum ER, sum of the effective spectrums EG1 and the effective spectrums EG2 equal the effective spectrum EG, and sum of the effective spectrums EB 1 and the effective spectrums EB2 equal the effective spectrum EB. Moreover, the combinations of the first spectrum light set and the second spectrum light set can be changed according to the designs of the color filters or requirements of the frames. For example, the first spectrum light set includes the second red spectrum light R2, the first green spectrum light G1, and the first blue spectrum light set B1, and the second spectrum light set includes the first red spectrum light R1, the second green spectrum light G2, and the second blue spectrum light set B2.

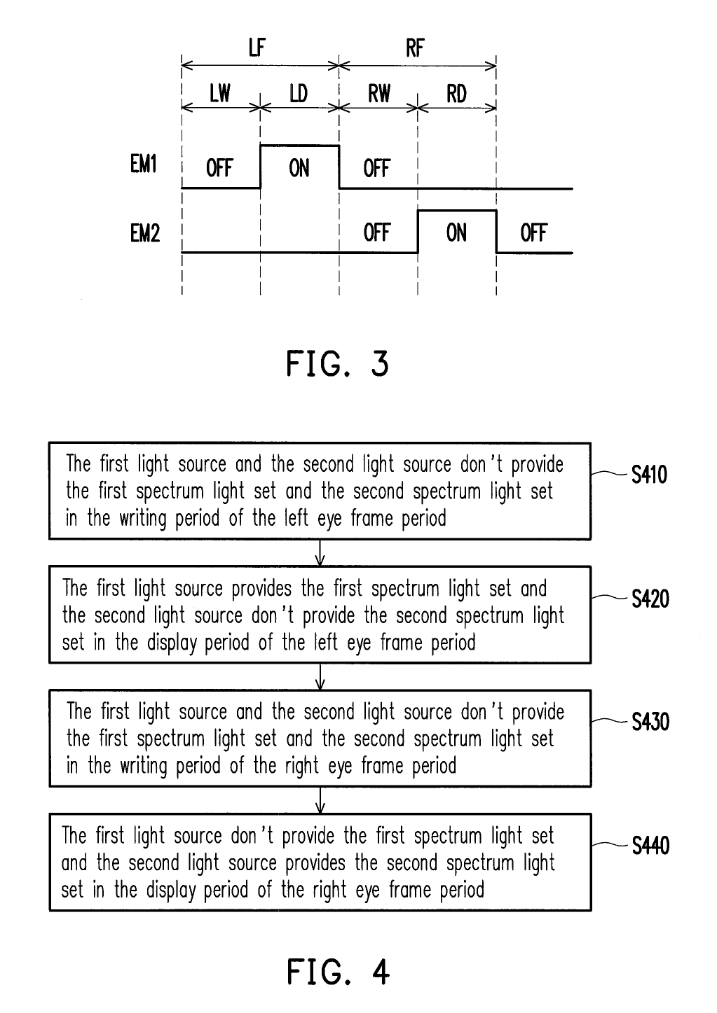

FIG. 3 is a driving schematic diagram of a first light source 133 and a second light source 135 in accordance with an embodiment of the invention. Referring to FIG. 1 and FIG. 3, in this embodiment, whether the first light source 133 and the second light source 135 offer the first spectrum light set and the second spectrum light set or not is controlled by whether the first light emitting element EM1 and the second light emitting element EM2 are turned on or not. The first light emitting element EM1 and the second light emitting element EM2 are turned off (as OFF status) in writing period LW (as the first writing period) of the left eye frame period LF (as the first frame period) to escape that left eye receives part of the previous right eye frame to generate the image sticking. The first light emitting element EM1 is turned on (as ON status) and the second light emitting element EM2 is turned off in display period LD (as the first display period) of the left eye frame period LF so as to let left eye receive the left eye frame.

In writing period RW (as the second writing period) of the right eye frame period RF (as the second frame period), similarly, the first light emitting element EM1 and the second light emitting element EM2 are turned off to escape that right eye receives part of the previous left eye frame to generate the image sticking. The first light emitting element EM1 is turned off and the second light emitting element EM2 is turned on in display period RD (as the second display period) of the light eye frame period RF so as to let right eye receive the right eye frame. The display period LD and RD can be a vertical blanking period respectively.

According to the above description, it can be compiled to a light source driving method to be used in the first light source 133 and the second light source 135 of the backlight module 130. FIG. 4 is a flowchart of the light source driving method in accordance with an embodiment of the invention. Referring to FIG. 4, the first light source and the second light source don't provide the first spectrum light set and the second spectrum light set in the writing period of the left eye frame period (step S410).

The first light source provides the first spectrum light set and the second light source doesn't provide the second spectrum light set in the display period of left eye frame period (step S420). The first light source and the second light source don't provide the first spectrum light set and the second spectrum light set in the writing period of the right eye frame period (step S430). The first light source doesn't provide the first spectrum light set and the second light source provides the second spectrum light set in the display period of the right eye frame period (step S440). The details of the above procedures can be referred the above explanations and not repeated here.

In summary, the stereo display device, the backlight module and the light source driving method thereof according to the embodiments of the invention, the left eye lens and the right eye lens of the color filter glasses masks the second spectrum light set and the first spectrum light set respectively. The left eye frame is transmitted through the first spectrum light set so that received by the left eye, and the right eye frame is transmitted through the second spectrum light set so that received by the right eye. The cost of the color filter glasses is lower than shutter glasses so that it can reduce the costs, and the display mode of left eye frame and right eye frame are like shutter glasses mode, so the frame resolution of the color filter glasses is higher than the frame resolution of the polarizing glasses.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A backlight module, comprising:
a light guide plate;
a first light source, disposed on a first side of the light guide plate, configured for providing a first spectrum light set in a first display period of a first frame period, wherein the first spectrum light set comprises a first red spectrum light, a first green spectrum light and a first blue spectrum light; and
a second light source, disposed on a second side opposite to the first side of the light guide plate, configured for providing a second spectrum light set in a second display period of a second frame period, wherein the second spectrum light set comprises a second red spectrum light, a second green spectrum light and a second blue spectrum light, and the second frame period is different from the first frame period;
wherein, effective spectrums of the first red spectrum light and effective spectrums of the second red spectrum light are located on effective spectrums of a red light, and effective spectrums of the first red spectrum light and effective spectrums of the second red spectrum light are not overlapped, effective spectrums of the first green spectrum light and effective spectrums of the second green spectrum light are located on effective spectrums of a green light, and effective spectrums of the first green spectrum light and effective spectrums of the second green spectrum light are not overlapped, effective spectrums of the first blue spectrum light and effective spectrums of the second blue spectrum light are located on effective spectrums of a blue light, and effective spectrums of the first blue spectrum light and effective spectrums of the second blue spectrum light are not overlapped.

2. The backlight module according to claim 1, wherein the first light source comprising:
a first light emitting element, configured for providing a light in the first display period; and
a first color filter, configured for transferring the light to the first spectrum light set.

3. The backlight module according to claim 2, wherein the second light source comprising:
a second light emitting element, configured for providing the light in the second display period; and
a second color filter, configured for transferring the light to the second spectrum light set.

4. The backlight module according to claim 1, wherein the first display period and the second display period are a vertical blanking period respectively.

5. The backlight module according to claim 1, wherein sum of effective spectrums of the first red spectrum light and effective spectrums of the second red spectrum light equals effective spectrums of the red light, sum of effective spectrums of the first green spectrum light and effective spectrums of the second green spectrum light equals effective spectrums of the green light, sum of effective spectrums of the first blue spectrum light and effective spectrums of the second blue spectrum light equals effective spectrums of the blue light.

6. A stereo display device, comprising:
a light guide plate;
a display panel, disposed on the light guide plate;
a first light source, disposed on a first side of the light guide plate, configured for providing a first spectrum light set in a first display period of a first frame period, wherein the first spectrum light set comprises a first red spectrum light, a first green spectrum light and a first blue spectrum light;
a second light source, disposed on a second side opposite to the first side of the light guide plate, configured for providing a second spectrum light set in a second display period of a second frame period, wherein the second spectrum light set comprises a second red spectrum light, a second green spectrum light and a second blue spectrum light, and the second frame period is different from the first frame period; and
a color filter glasses, having a first lens and a second lens, the first lens configured for masking the second spectrum light set, the second lens configured for masking the first spectrum light set;
wherein, effective spectrums of the first red spectrum light and effective spectrums of the second red spectrum light are located on effective spectrums of a red light, and effective spectrums of the first red spectrum light and effective spectrums of the second red spectrum light are not overlapped, effective spectrums of the first green spectrum light and effective spectrums of the second green spectrum light are located on effective spectrums of a green light, and effective spectrums of the first green spectrum light and effective spectrums of the second green spectrum light are not overlapped, effective spectrums of the first blue spectrum light and effective spectrums of the second blue spectrum light are located on effective spectrums of a blue light, and effective spectrums of the first blue spectrum light and effective spectrums of the second blue spectrum light are not overlapped.

7. The stereo display device according to claim 6, wherein the first light source comprising:
a first light emitting element, configured for providing a light in the first display period; and
a first color filter, configured for transferring the light to the first spectrum light set.

8. The stereo display device according to claim 7, wherein the second light source comprising:
a second light emitting element, configured for providing the light in the second display period; and
a second color filter, configured for transferring the light to the second spectrum light set.

9. The stereo display device according to claim 6, wherein the first display period and the second display period are a vertical blanking period respectively.

10. The stereo display device according to claim 6, wherein the display panel is a LCD display panel.

11. The stereo display device according to claim 6, wherein sum of effective spectrums of the first red spectrum light and effective spectrums of the second red spectrum light equals effective spectrums of the red light, sum of effective spectrums of the first green spectrum light and effective spectrums of the second green spectrum light equals effective spectrums of the green light, sum of effective spectrums of the first blue spectrum light and effective spectrums of the second blue spectrum light equals effective spectrums of the blue light.

12. The stereo display device according to claim 6, wherein the first display period and the second display period are configured for displaying a left eye frame and a right eye frame respectively.

13. A light source driving method, adapted for a backlight module of a stereo display device having a first light source and a second light source, the first light source configured for providing a first spectrum light set comprising a first red spectrum light, a first green spectrum light and a first blue spectrum light, the second light source configured for providing a second spectrum light set comprising a second red spectrum light, a second green spectrum light and a second blue spectrum light, wherein effective spectrums of the first red spectrum light and effective spectrums of the second red spectrum light are located on effective spectrums of a red light and not overlapped, effective spectrums of the first green spectrum light and effective spectrums of the second green spectrum light are located on effective spectrums of a green light and not overlapped, and effective spectrums of the first blue spectrum light and effective spectrums of the second blue spectrum light are located on effective spectrums of a blue light and not overlapped, the light source driving method comprising:
the first light source and the second light source not providing the first spectrum light set and the second spectrum light set in a first writing period of a first frame period;
the first light source providing the first spectrum light set, the second light source not providing the second spectrum light set in a first display period of the first frame period;
the first light source and the second light source not providing the first spectrum light set and the second spectrum light set in a second writing period of a second frame period; and
the first light source not providing the first spectrum light set, the second light source providing the second spectrum light set in a second display period of the second frame period.

14. The light source driving method according to claim 13, wherein the first display period and the second display period are a vertical blanking period respectively.

15. The light source driving method according to claim 13, wherein the first frame period is neighbored to the second frame period.
